(19) United States
(12) Patent Application Publication
(10) Pub. No.: US 2010/0013852 A1
(43) Pub. Date: Jan. 21, 2010

(54) TOUCH-TYPE MOBILE COMPUTING DEVICE AND DISPLAYING METHOD APPLIED THERETO

(75) Inventor: Kuan-Lin Liu, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/500,916

(22) Filed: Jul. 10, 2009

(30) Foreign Application Priority Data
Jul. 18, 2008 (TW) 097127481

(51) Int. Cl. G09G 5/02

(52) U.S. Cl. 345/592; 345/589; 345/173; 345/158

(57) ABSTRACT

A touch-sensitive mobile computing device includes a main body, a display screen and a touch-sensitive interface. The display screen is disposed on the main body for showing a virtual keyboard. The touch-sensitive interface is disposed on the display screen. When a touching position of the touch-sensitive interface is touched, a pointer is shown on the display screen and in the vicinity of the touching position to point a first virtual key of the virtual keyboard, so that the first virtual key pointed by the pointer exhibits a highlight effect and a distortion effect.

### FIELD OF THE INVENTION

The present invention relates to a touch-sensitive mobile computing device, and more particularly to a touch-sensitive mobile computing device having a function of pointing and highlighting a virtual key when the virtual key is touched. The present invention also relates to a displaying method of the touch-sensitive mobile computing device.

### BACKGROUND OF THE INVENTION

For operating electronic devices, keyboards, mice, trackballs or remote controllers are important user interfaces for controlling cursors or inputting instructions. Recently, mobile computing devices with touch screens or touch panels become increasingly popular because of their ease and versatility of operation. In other words, the touch screen or touch panel is a man-machine interface (MMI) between the user and the hardware components or software of the mobile computing device.

By simply touching a touch-sensitive interface of a touch screen or touch panel with a finger or a touching tool (e.g. a stylus), the user can select a function item of a menu option or a toolbar, a program file or an icon so as to execute associated functions. When a finger or a touching tool touches the touch-sensitive interface, an electronic signal indicative of the magnitude of the exerted force and the touching position will be generated. In response to the electronic signal, the operating system executes a corresponding instruction. As such, the touch-sensitive interface gradually replaces the conventional user interface of the electronic device because more space of the hardware components is saved and the user-friendliness is enhanced.

Since the mobile computing device is usually small-sized, the display screen is small. If the mobile computing device also includes physical keys or keyboards, the space for arranging the display screen is shrunken. For utilizing the area of the touch-sensitive interface, the area of the display screen is as large as possible and the area of mounting the physical keys or keyboard is as small as possible.

Generally, the use of the finger to operate the touch-sensitive interface is more convenient than the use of the stylus because it is troublesome to take out or find out the stylus. Since the pixel numbers of the display screen are limited, the finger usually fails to precisely touch and control the virtual keyboard or the tiny targets of the electronic map on the display screen. Under this circumstance, erroneous operation is readily caused.

For solving the above drawbacks, several technologies have been developed. For example, the icon shown on the display screen is enlarged. Alternatively, a multi-touch technology has been proposed. According to the multi-touch technology, the target is rotated, moved, or spread farther apart or closer together by touching a single finger or two fingers on the touch-sensitive interface.

FIG. 1 is a schematic diagram illustrating a touching technology applied to a mobile computing device according to the prior art. As shown in FIG. 1, a virtual keyboard 12 is displayed in a touch screen 11. By using a finger 13 to touch a key of the virtual keyboard 12, a corresponding character, sign or number is inputted into the mobile computing device. When the finger 13 is placed on a touching position, a cursor 14 is shown in the vicinity of the touching position to point to a specified virtual key. In particular, when the finger 13 is placed on a touching position, the virtual key 121 pointed by the cursor 14 is highlighted.

Furthermore, a zoom-in box (not shown) is optionally arranged beside the touching position for showing an enlarged image of the target (e.g. a letter) pointed by the cursor. When the cursor is moved to another touching position, the zoom-in box is also moved to show the enlarged image of the target pointed by the cursor and thus the user could precisely find out a desired target. In addition, via the zoom-in box, the virtual key at the edges of the display screen or the tiny targets of the electronic map become visible in order to facilitate the user to precisely touch and control the touch screen.

Therefore, there is a need of designing an intuitive, simple and easy-to-use touch-sensitive mobile computing device while accurately executing the selected functions. Moreover, user-friendliness and amusement efficacy should be also taken into consideration in order to increase the user's desire for operating the touch-sensitive mobile computing device.

### SUMMARY OF THE INVENTION

The present invention provides a touch-sensitive mobile computing device and a displaying method applied to the touch-sensitive mobile computing device, thereby enhancing the touch feel on the visual keyboard, the amusement efficacy, and the convenience and accuracy of inputting characters.

In accordance with an aspect of the present invention, there is provided a touch-sensitive mobile computing device. The touch-sensitive mobile computing device includes a main body, a display screen and a touch-sensitive interface. The display screen is disposed on the main body for showing a virtual keyboard. The touch-sensitive interface is disposed on the display screen. When a touching position of the touch-sensitive interface is touched, a pointer is shown on the display screen and in the vicinity of the touching position to point a first virtual key of the virtual keyboard, so that the first virtual key pointed by the pointer exhibits a highlight effect and a distortion effect.

In accordance with another aspect of the present invention, there is provided a displaying method of a touch-sensitive mobile computing device. The touch-sensitive mobile computing device includes a main body, a display screen and a touch-sensitive interface. Firstly, a virtual keyboard on the display screen is shown. Then, a touching position of the touch-sensitive interface is touched such that a translucent pointer is shown in the vicinity of the touching position and points to a first virtual key of the virtual keyboard. The first virtual key pointed by the pointer exhibits a highlight effect and a distortion effect.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a touching technology applied to a mobile computing device according to the prior art;

FIG. 2A is a schematic view illustrating a touch-sensitive personal digital assistant according to an embodiment of the present invention;

FIG. 2B is a schematic function block diagram illustrating the touch-sensitive personal digital assistant of FIG. 2A;

FIGS. 3A and 3B schematically illustrate the operations of the virtual keyboard of the touch-sensitive personal digital assistant according to an embodiment of the present invention;

FIGS. 4A and 4B schematically illustrate the operations of the virtual keyboard of the touch-sensitive personal digital assistant according to another embodiment of the present invention; and

FIG. 5 schematically illustrates a flowchart of a displaying method of the touch-sensitive mobile computing device according to the present invention.

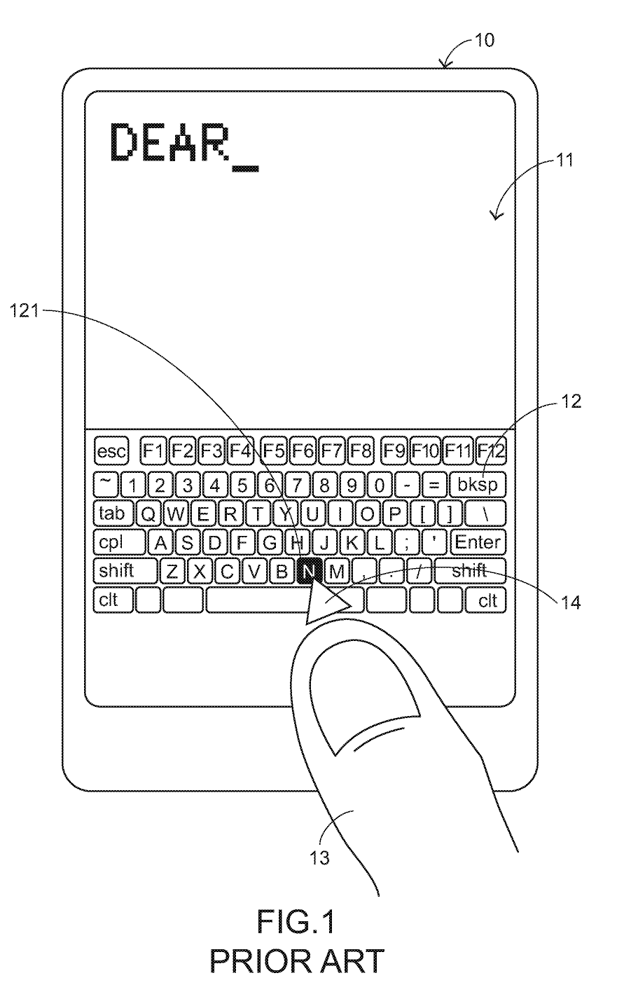

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a touch-sensitive mobile computing device and a displaying method of the touch-sensitive mobile computing device. An example of the touch-sensitive mobile computing device includes but is not limited to a smart phone, a mobile phone, a personal digital assistant (PDA), a digital walkman, an e-book reader, a notebook computer, a GPS satellite navigator or a handheld computer. Hereinafter, the touch-sensitive mobile computing device is illustrated by referring to a personal digital assistant.

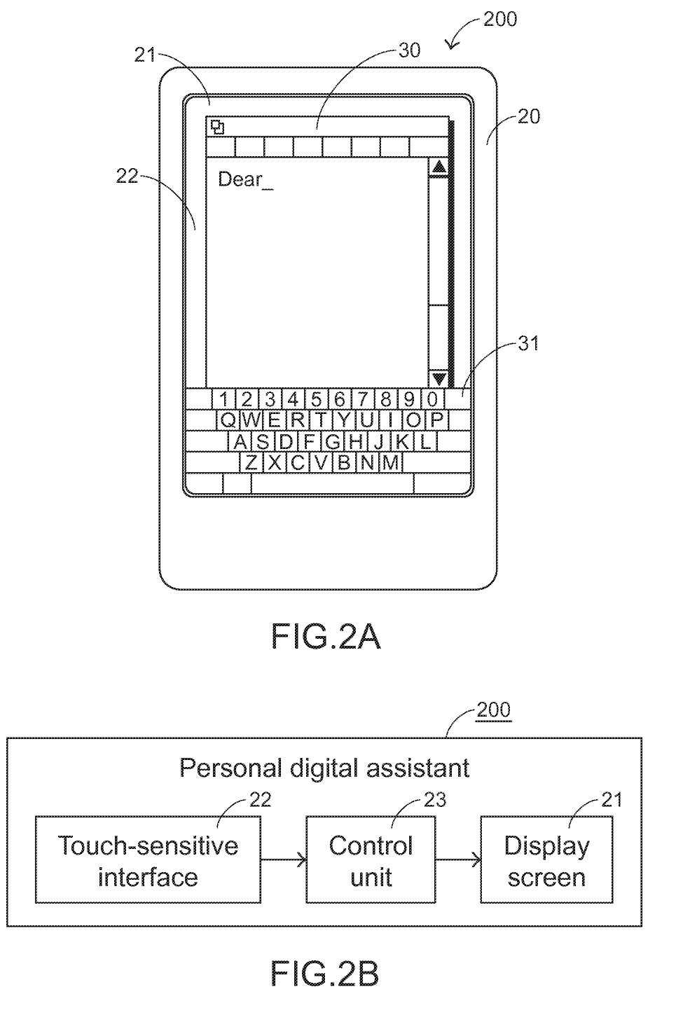

FIG. 2A is a schematic view illustrating a touch-sensitive personal digital assistant according to an embodiment of the present invention. As shown in FIG. 2A, the touch-sensitive personal digital assistant 200 comprises a main body 20, a display screen 21 and a touch-sensitive interface 22. The touch-sensitive personal digital assistant 200 is executed under an operating system having a desktop environment and a graphics-based operating frame. The display screen 21 is disposed on the main body 20 for showing an operating frame 30 running under the operating system. The touch-sensitive interface 22 is made of a transparent material. The touch-sensitive interface 22 is directly disposed over the display screen 21 so as to be collectively defined as a touch screen.

By touching a finger or a touching tool (e.g. a stylus) on the touch-sensitive interface 22, the user can input an instruction to control operations of the touch-sensitive personal digital assistant 200. In particular, when the user's finger or the stylus touches the touch-sensitive interface 22, the user can select a function item of a menu option or a toolbar, a program file or an icon so as to execute associated functions.

For example, the operating frame 30 shown on the display screen 21 includes an input frame of an electronic mail. In addition, a virtual keyboard 31 created by the operating system is also shown on the display screen 21. By touching the virtual keys of the virtual keyboard 31, the user could input a corresponding character, sign or number.

As shown in FIG. 2A, the character input operation of the personal digital assistant 200 includes the process of editing a document file or an electronic mail. Alternatively, the character input operation of the personal digital assistant 200 includes the process of inputting the website address to be linked to the Internet. For example, after the cursor is firstly pointed to an address bar at the upper side of a web page, a virtual keyboard is shown for inputting characters. On the other hand, the virtual keyboard is shown by a single touch on the input frame.

FIG. 2B is a schematic function block diagram illustrating a touch-sensitive personal digital assistant of the present invention. As shown in FIG. 2B, the touch-sensitive personal digital assistant 200 further comprises a control unit 23. The control unit 23 is disposed within the main body 20 and communicates with the touch-sensitive interface 22 and the display screen 21. The control unit 23 could control operations of the touch-sensitive personal digital assistant 200 and process instructions. Via the touch-sensitive interface 22, the user can input an instruction. In response to the instruction, the control unit 23 controls the image shown on the display screen 21.

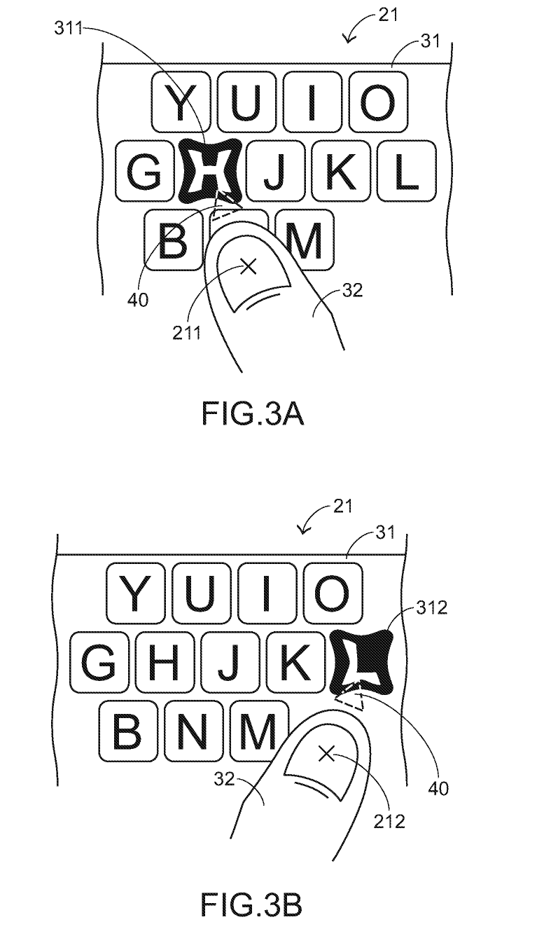

FIGS. 3A and 3B schematically illustrate the operations of the virtual keyboard of the touch-sensitive personal digital assistant according to an embodiment the present invention. For clarification and brevity, only a portion of the virtual keyboard 31 is shown on the display screen 21. As shown in FIG. 3A, the user's finger 32 is placed on a first touching position 211 of the display screen 21. The first touching position 211 is located on the virtual keyboard 31. Meanwhile, a translucent pointer 40 is shown in the vicinity of the first touching position 211. For recognition, the pointer 40 is disposed at the upper side of the first touching position 211. In addition, the pointer 40 is a translucent cursor icon, and thus the user can clearly recognize the virtual key under the pointer 40.

As shown in FIG. 3A, the pointer 40 points to a first virtual key 311 of the virtual keyboard 31. Moreover, the first virtual key 311 pointed by the pointer 40 exhibits a highlight effect and a distortion effect. The highlight effect indicates that the first virtual key 311 is distinguished from other virtual keys of the virtual keyboard 31 in the color tone. Alternatively, the highlight effect indicates that the character and the background of the first virtual key 311 have different color tones. For example, the background of the first virtual key 311 has a dark color tone but the character of the first virtual key 311 has a light color tone. The distortion effect indicates that the edges of the first virtual key 311 are internally concave and the dimension and shape of the character are distorted to be distinguished from the neighboring virtual keys. Due to the distortion effect, the user may feel that the first virtual key 311 is depressed. In other words, the distortion effect causes a vision feedback to facilitate the user to recognize the virtual key to be selected.

In an embodiment, after the virtual keyboard 31 has been touched for a certain time period, the pointer 40 is shown. By precisely moving the pointer 40 to point to a desired virtual key, the pointed virtual key exhibits the highlight and distortion effects. As shown in FIG. 3A, the letter “H” is pointed by the pointer 40. After the finger 32 leaves the virtual keyboard 31, the letter “H” is inputted into the input frame or a corresponding instruction is executed by the operating system. Moreover, after the pointer 40 is shown, the finger 32 could be moved to another touching position of the virtual keyboard 31 such that the pointer 40 points to another virtual key.

For example, as shown in FIG. 3B, when the finger 32 moves from the first touching position 211 to a second touching position 212, the pointer 40 points to a second virtual key 312 of the virtual keyboard 31. As shown in FIG. 3B, the letter “L” is pointed by the pointer 40. After the finger 32 leaves the virtual keyboard 31, the letter “L” is inputted into the input frame or a corresponding instruction is executed by the operating system. Similarly, the second virtual key 312 pointed by the pointer 40 also exhibits a highlight effect and a distortion effect. In other words, the background of the second virtual key 312 has a dark color tone but the character of the second virtual key 312 has a light color tone, so that the character and the background of the second virtual key 312 have different color tones. In addition, the edges of the second virtual key 312 are internally concave and the dimension and shape of the character are distorted to be distinguished from the neighboring virtual keys. The distortion effect causes a vision feedback to facilitate the user to recognize the virtual key to be selected.

Moreover, if the finger 32 moves from the first touching position 211 to the second touching position 212 along a linear path, the letters “H”, “3”, “K” and “L” are successively pointed by the pointed so as to successively exhibit the highlight and distortion effects. Under this circumstance, the user may feel that a series of keys successively bounce on the display screen 21. Due to the vision feedback, the touch feel on the visual keyboard and the amusement efficacy are both enhanced. In addition, since the shape, dimension and the color tone of pointed virtual key are distinguished from the neighboring virtual keys, the user could clearly recognize the pointing direction of the pointer 40 or the virtual key pointed by the pointer 40.

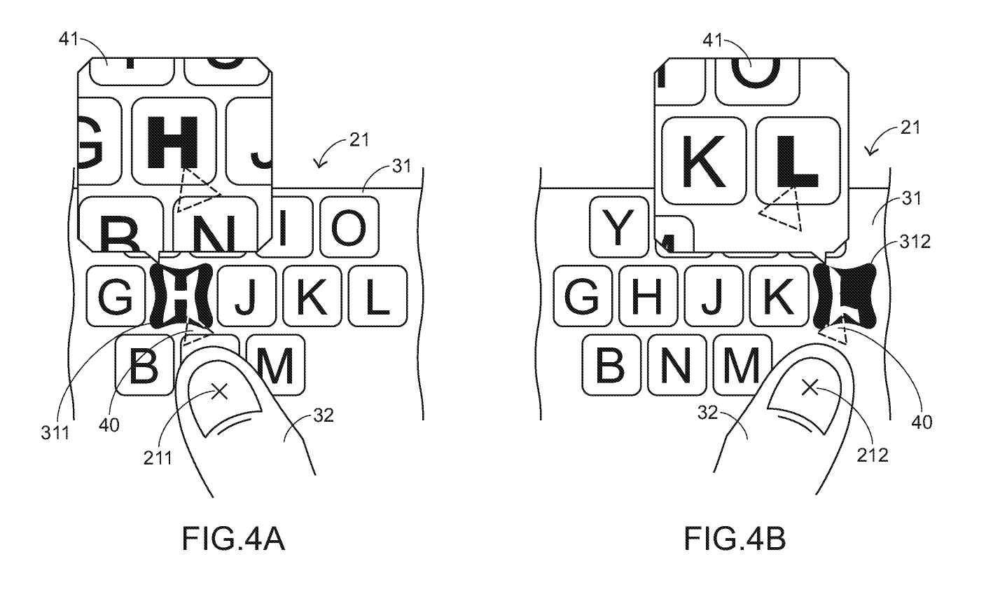

It is noted that, however, those skilled in the art will readily observe that numerous modifications and alterations may be made while retaining the teachings of the invention. For example, the zoom-in technology could be combined with the displaying method of the present invention. FIGS. 4A and 4B schematically illustrate the operations of the virtual keyboard of the touch-sensitive personal digital assistant according to another embodiment of the present invention. As shown in FIG. 4A, the first virtual key 311 pointed by the pointer 40 exhibits a highlight effect and a distortion effect similar to those shown in FIG. 3A. In addition, a zoom-in box 41 that is beside the pointed virtual key 311 is also shown on the display screen 21. The zoom-in box 41 contains an enlarged image of the letter “H”. As shown in FIG. 4B, the second virtual key 312 pointed by the pointer 40 exhibits a highlight effect and a distortion effect similar to those shown in FIG. 3B. In addition, a zoom-in box 41 that is beside the pointed virtual key 312 is also shown on the display screen 21. The zoom-in box 41 contains an enlarged image of the letter “L”. Via the zoom-in box 41, the pointed virtual key and its neighboring virtual keys could be clearly viewed. As such, the finger 32 could precisely touch and control the virtual keyboard 31 even if the area of the display screen 21 is very small.

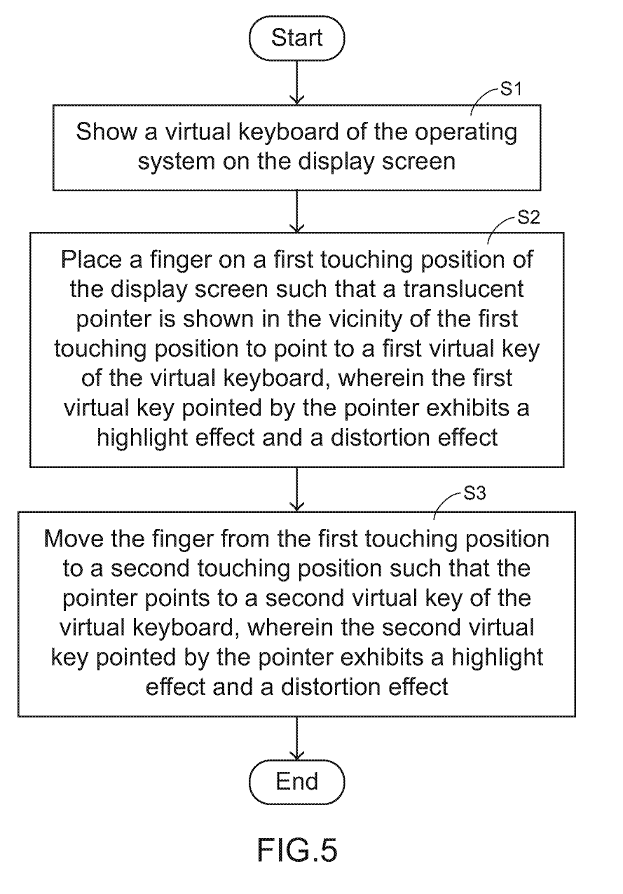

Hereinafter, a displaying method of the touch-sensitive mobile computing device of the present invention is described with reference to a flowchart of FIG. 5. Firstly, a virtual keyboard 31 executed under the operating system is shown on the display screen 21 (Step S1). Next, the finger 32 is placed on a first touching position 211 of the display screen 21, and thus a translucent pointer 40 is shown in the vicinity of the first touching position 211 to point to a first virtual key 311 of the virtual keyboard 31, wherein the first virtual key 311 pointed by the pointer 40 exhibits a highlight effect and a distortion effect (Step S2). Next, the finger 32 moves from the first touching position 211 to a second touching position 212. As such, the pointer 40 points to a second virtual key 312 of the virtual keyboard 31, wherein the second virtual key 312 pointed by the pointer 40 exhibits a highlight effect and a distortion effect (Step S3).

In the above embodiments, the virtual keyboard shown on the touch-sensitive interface is operated by touching a finger on a touching position. Since the virtual key pointed by the pointer exhibits a highlight effect and a distortion effect and a zoom-in box is shown for facilitate the user to view a target pointed by the pointer, the use of the finger could precisely touch and control the virtual keyboard or the tiny targets of the electronic map on the display screen. The above embodiments are illustrated by referring to the user of the finger to operate the virtual keyboard. Nevertheless, the use of a touching tool (e.g. a stylus) is also applied to the present invention. Similarly, the virtual key pointed by the pointer also exhibits a highlight effect and a distortion effect when the stylus is used to touch and control the virtual keyboard.

From the above description, the displaying method of the present invention can facilitate the user to clearly and accurately recognize the virtual key because the virtual key pointed by the pointer exhibits a highlight effect and a distortion effect. Due to the highlight effect and the distortion effect, the color tone, shape and/or dimension of the pointed virtual key are very distinguished from the neighboring virtual keys. As a consequence, the touch feel on the visual keyboard and the amusement efficacy are both enhanced and the user's desire for operating the touch-sensitive mobile computing device is increased. Moreover, the displaying method of the present invention can facilitate the user to accurately execute the function of a desired function item or icon in order to quickly input characters into the input frame.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch-sensitive mobile computing device comprising:
a main body;
a display screen disposed on the main body for showing a virtual keyboard; and
a touch-sensitive interface disposed on the display screen, wherein when a touching position of the touch-sensitive interface is touched, a pointer is shown on the display screen and in the vicinity of the touching position to point a first virtual key of the virtual keyboard, so that the first virtual key pointed by the pointer exhibits a highlight effect and a distortion effect.

2. The touch-sensitive mobile computing device according to claim 1 further comprising a control unit disposed within the main body and communicating with the touch-sensitive interface and the display screen for controlling operations of the touch-sensitive interface.

3. The touch-sensitive mobile computing device according to claim 1 wherein the first virtual key with the highlight effect is distinguished from other virtual keys of the virtual keyboard in the color tone, or the character and the background of the first virtual key with the highlight effect have different the color tones.

4. The touch-sensitive mobile computing device according to claim 1 wherein the first virtual key with the distortion effect is internally concave and has distorted dimension and shape.

5. The touch-sensitive mobile computing device according to claim 1 wherein a zoom-in box is shown on the display screen and beside the pointed for showing an enlarged image of the first virtual key.

6. The touch-sensitive mobile computing device according to claim 1 wherein a zoom-in box is shown on the display screen and beside the pointed for showing an enlarged image that covers a target pointed by the pointer.

7. The touch-sensitive mobile computing device according to claim 1 wherein the touch-sensitive mobile computing device is executed under an operating system, an operating frame is generated by the operating system, and a corresponding character, sign or number is shown on the operating system by operating the virtual keyboard.

8. The touch-sensitive mobile computing device according to claim 1 wherein the pointer is disposed at an upper side of the touching position.

9. The touch-sensitive mobile computing device according to claim 1 wherein the point is translucent.

10. The touch-sensitive mobile computing device according to claim 1 wherein when a second virtual key of the virtual keyboard is pointed by the pointer, the second virtual key exhibits the highlight effect and the distortion effect.

11. A displaying method of a touch-sensitive mobile computing device, the touch-sensitive mobile computing device comprising a main body, a display screen and a touch-sensitive interface, the displaying method comprising steps of:
showing a virtual keyboard on the display screen; and
touching a touching position of the touch-sensitive interface such that a translucent pointer is shown in the vicinity of the touching position and points to a first virtual key of the virtual keyboard, wherein the first virtual key pointed by the pointer exhibits a highlight effect and a distortion effect.

12. The displaying method according to claim 11 further comprising a step of moving the pointer to point to a second virtual key of the virtual keyboard, wherein the second virtual key exhibits the highlight effect and the distortion effect.

13. The displaying method according to claim 11 further comprising a step of showing a zoom-in box beside the pointed for showing an enlarged image of the first virtual key.

14. The displaying method according to claim 11 further comprising a step of showing a zoom-in box beside the pointed for showing an enlarged image that covers a target pointed by the pointer.

15. The displaying method according to claim 11 wherein the touch-sensitive mobile computing device is executed under an operating system, an operating frame is generated by the operating system, and a corresponding character, sign or number is shown on the operating system by operating the virtual keyboard.
